(19) United States
(12) Patent Application Publication
(10) Pub. No.: US 2023/0413911 A1
(43) Pub. Date: Dec. 28, 2023

(54) AEROSOL PROVISION DEVICE

(71) Applicant: Nicoventures Trading Limited, LONDON (GB)

(72) Inventors: David BUREAU, London (GB); James SHERIDAN, London (GB); Daniel LOCHTMAN, London (GB)

(21) Appl. No.: 18/248,310

(22) PCT Filed: Oct. 12, 2021
(86) PCT No.: PCT/EP2021/078204

§ 371 Date: Apr. 7, 2023

(30) Foreign Application Priority Data
Oct. 16, 2020 (GB) 2016478.6

(51) Int. Cl. A24F 40/465; A24F 40/20; A24F 40/85

(52) U.S. Cl. CPC A24F 40/465; A24F 40/20; A24F 40/85

(57) ABSTRACT

An aerosol provision device and systems as well as related methods of using. The aerosol provision device has a device housing defining a device chamber, a heating element protruding into the chamber from an end of the device chamber, and a receptacle defining a heating chamber arranged to receive at least a portion of a consumable including aerosolizable material. The receptacle is at least partially removably disposed within the device chamber and includes a contact feature arranged to make sliding contact with the heating element during removal of the receptacle from the device chamber.

### PRIORITY CLAIM

The present application is a National Phase entry of PCT Application No. PCT/EP2021/078204, filed Oct. 12, 2021, which claims priority from GB Application No. 2016478.6, filed Oct. 16, 2020, each of which hereby fully incorporated herein by reference.

### TECHNICAL FIELD

The present invention relates to an aerosol provision device. The present invention also relates to methods of using the aerosol provision device, and an aerosol provision system comprising the aerosol provision device and an article comprising aerosol generating material.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

In accordance with some embodiments described herein, there is provided an aerosol provision device comprising a device housing defining a device chamber, a heating element protruding into the device chamber from an end of the device chamber, a receptacle defining a heating chamber arranged to receive at least a portion of a consumable comprising aerosolisable material. The receptacle is at least partially removably disposed within the device chamber and comprises a contact feature arranged to make sliding contact with the heating element during removal of the receptacle from the device chamber.

The receptacle may comprise a base and the heating element is arranged to protrude through the base into the heating chamber. The base may form the contact feature. The base may further comprise an aperture through which the heating element extends, wherein the contact feature is defined by at least part of a side of the aperture. The base may comprise a resilient material. The base may locate at the end of the device chamber.

The receptacle may further comprise a wall projecting from the base to define the heating chamber that encircles the heating element protruding into the device chamber.

The receptacle may further comprise a lip configured to protrude from the device chamber.

The receptacle may be removably secured in the device chamber.

The heating element may be retractable from the device chamber.

The heating element may comprise a susceptor which is heatable by penetration with a varying magnetic field. An inductor coil may extend around the susceptor, wherein the inductor coil is configured to generate the varying magnetic field.

The heating element may be substantially blade-shaped. The sides of the aperture may be sized and shaped to make sliding contact with the substantially blade-shaped heating element.

The heating element may be a substantially pin-shaped. The sides of the aperture may be sized and shaped to make sliding contact with the substantially pin-shaped heating element.

The aerosol provision device may be a non-combustible aerosol provision device.

The aerosol provision device may be configured to heat non-liquid aerosolisable material.

In some embodiments described herein, there is provided a system, comprising a consumable and an aerosol provision device. The aerosol provision device comprises a device housing defining a device chamber, a heating element protruding into the chamber from an end of the device chamber, a receptacle defining a heating chamber arranged to receive at least a portion of a consumable comprising aerosolisable material. The receptacle is at least partially removably disposed within the device chamber and comprises a contact feature arranged to make sliding contact with the heating element during removal of the receptacle from the device chamber.

The receptacle may comprise a base and the heating element is arranged to protrude through the base into the heating chamber. The base may form the contact feature. The base may further comprise an aperture through which the heating element extends, wherein the contact feature is defined by at least part of a side of the aperture. The base may locate at the end of the device chamber. The receptacle may further comprise a wall projecting from the base to define the heating chamber that encircles the heating element protruding into the device chamber. The receptacle may further comprise a lip configured to protrude from the device chamber. The receptacle may be removably secured in the device chamber.

In some embodiments described herein, there is provided a method of using the aerosol provision device as described above. The method comprises removing the receptacle from the consumable chamber of the device housing and using the aperture to scrape along the heating element to clean the heating element during removal of the receptacle.

In some embodiments described herein, there is provided an aerosol provision system comprising an aerosol provision device as described above and an article comprising aerosol generating material, wherein the article is dimensioned to be at least partially received within the heater assembly.

In some embodiments described herein, there is provided an aerosol provision device comprising: a device housing defining a device chamber; a heating element protruding into the device chamber from an end of the device chamber; an insert at least partially removably disposed within the device chamber, the insert comprising a contact feature arranged to make sliding contact with the heating element during removal of the insert from the device chamber.

In accordance with some embodiments described herein, there is provided an aerosol provision device comprising a device housing defining a device chamber, a heating element protruding into the device chamber from an end of the device chamber, a receptacle defining a heating chamber arranged to receive at least a portion of a consumable comprising aerosolisable material. The receptacle is at least partially removably disposed within the device chamber. The receptacle may comprise a scraper arranged to scrape the heating element during removal of the receptacle from the device chamber.

In accordance with some embodiments described herein, there is provided a receptacle for an aerosol provision device, the receptacle comprising: a heating chamber arranged to receive at least a portion of a consumable comprising aerosolisable material, wherein the receptacle is at least partially removably disposed within a housing of the aerosol provision device; the receptacle being arranged to removably receive a heating element in the housing; and a contact feature arranged to make sliding contact with a heating element of the aerosol provision device during at least one of insertion and removal of the receptacle from the housing.

### BRIEF DESCRIPTION OF THE DRAWINGS

Embodiments of the invention will now be described, by way of example only, with reference to the accompanying drawings, in which:

FIG. 1 shows a schematic cross-sectional view of an example non-combustible aerosol provision device;

FIG. 2A shows a schematic cross-sectional view of an example of a device housing and removable receptacle of an example aerosol provision device;

FIG. 2B shows a schematic cross-sectional view of another example of a device housing and removable receptacle of an example aerosol provision device;

FIG. 3A shows a schematic end view of an example of a removable receptacle; and

FIG. 3B shows a schematic end view of another example of a removable receptacle.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

As used herein, the term “consumable” includes an article that comprises includes or contains in use the aerosol generating material that can be inserted into an aerosol provision device.

Consumables used in aerosol provision devices may, on occasion, leave residue in a compartment or chamber in which it is heated. This may be cumbersome since the removal of residue left by a consumable may be difficult to remove from the compartment or chamber after use.

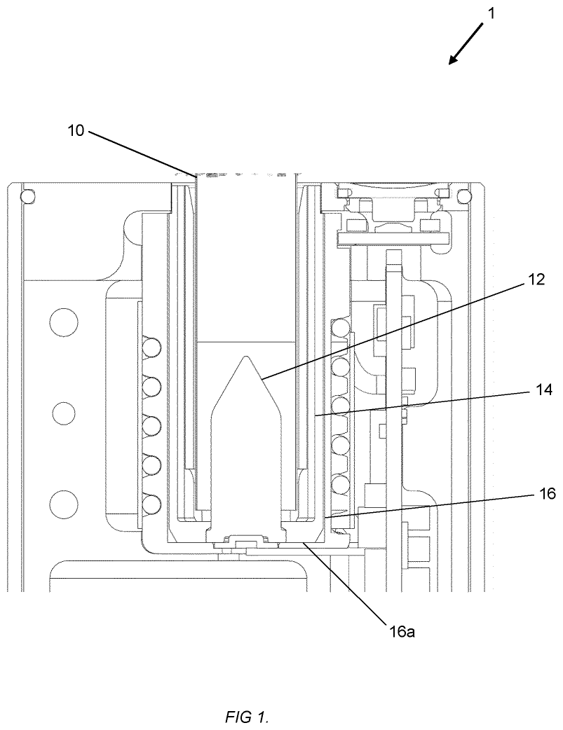

Referring to FIG. 1, there is shown a general example of an aerosol provision device 1. The aerosol provision device 1 includes a device housing 16 and a receptacle 14. The device housing 16 defines a device chamber (not shown) for receiving the receptacle 14 and a consumable 10. The receptacle 14 acts as an insert. That is the insert comprises a feature insertable into the device chamber. As shown in FIG. 1, there may be provided a heating element 12 on an end 16a of the device housing 16. The receptable 14 defines a space (referred to herein as a “heating chamber”) that receives the consumable 10. The heating element 12 protrudes from the end 16a of the device housing 16 through to the heating chamber that is defined by the receptacle 14. In use, the consumable 10 is inserted into the heating chamber to engage the heating element 12.

Although not shown in FIG. 1, it is envisaged that the receptacle 14 can be removable from the device housing 16. In some embodiments, the heating element 12 may also be removable. In some embodiments, the receptacle 14 is fixed to the device housing 16, and only the heating element 12 is removable.

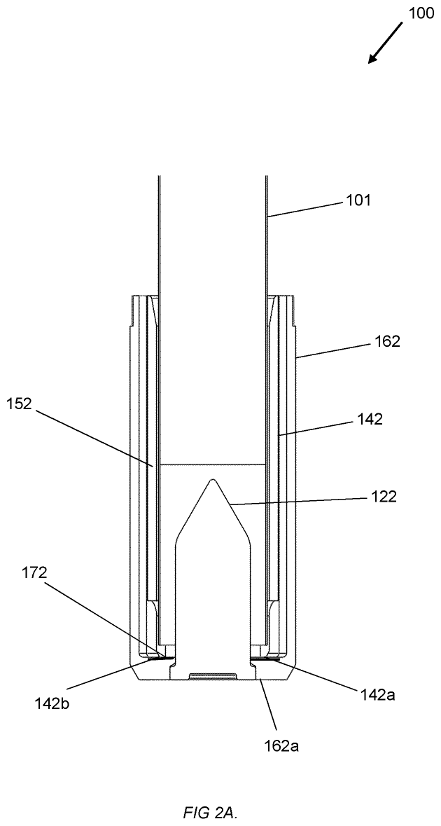

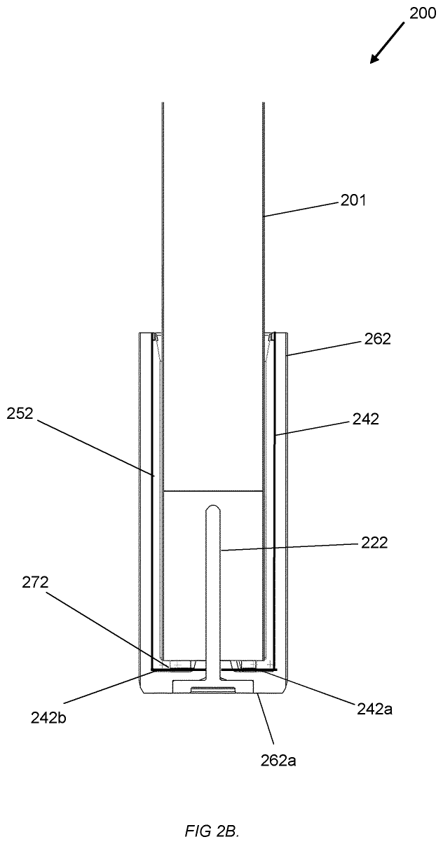

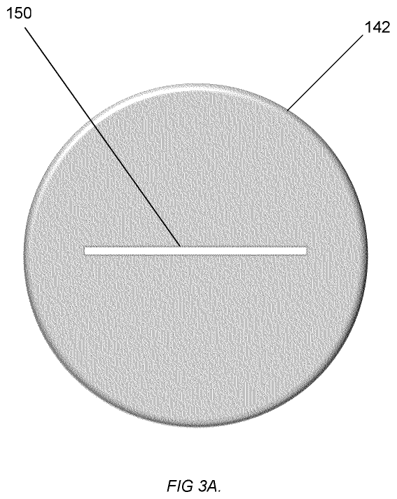

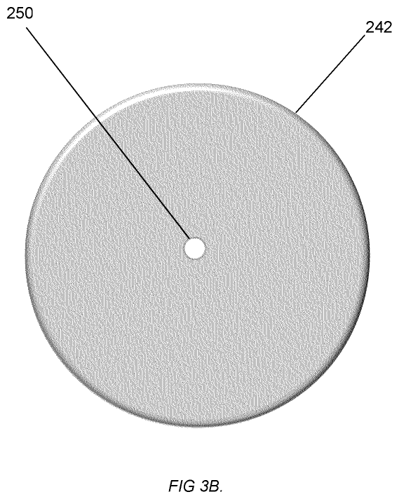

Referring to FIG. 2A, there is shown a schematic cross-section of an example of an aerosol provision device 100. Similar to FIG. 1, there is shown a consumable 101, a device housing 162, a receptacle 142 and a heating element 122. The receptacle 142 may be inserted into device housing 162. As shown in FIG. 2A, the receptacle 142 defines a heating chamber in which the consumable 101 may be inserted. The heating element 122 extends from an end 162a of the device housing 162 and protrudes from the end 162a of the device housing 162 into the heating chamber that is defined by the receptacle 142. The consumable 101 may then be inserted into the heating chamber to engage with the heating element 122. The receptacle 142 comprises a base 172. The base 172 is provided with an aperture 150 (for example, as shown in FIG. 3A). The base 172 defines a peripheral edge of the aperture. The edge defines a first side 142a and a second side 142b. The aperture 150 is the same shape as the heating element 122. The aperture 150 allows for the heating element 122 to protrude into the heating chamber, but also allows for sliding contact of the first side 142a and the second side 142b against the heating element 122. The base 172 acts as a contact feature arranged to make sliding contact with the heating element 122. The contact feature, in embodiments, is another feature protruding above or below the base 172, for example a flange or a scraper (not shown). The receptacle further comprises a wall 152 projecting from the base 172 to define the heating chamber that encircles the heating element 122 protruding into the heating chamber. The receptacle, in embodiments, includes a lip (not shown) that protrudes from the device chamber that allows the user to easily remove and insert the receptacle.

In FIG. 2A, the heating element 122 is shown as a substantially blade-shaped heating element.

In use, the receptacle 142 is inserted into the device housing 162 such that the sides 142a and 142b contact the heating element 122 and allow the heating element 122 through the aperture. The consumable 101 is then inserted into the heating chamber defined by the receptacle 142 to engage with the heating element 122. Once the consumable 101 has been heated within the heating chamber, and used by the user, the consumable 101 is removed from the aerosol provision device 100. The removal of the consumable 101 may leave residue around the heating element 122. Therefore, after use, the user may remove the receptacle 142. The first and second sides, 142a and 142b, allow for residue to be removed by contacting, and scraping, the heating element 122, and moving the residue off the heating element 122 as the receptacle 142 is removed. This allows for residue to be contained in the receptacle 142 after it has been removed from the device housing 162. The residue remaining in the receptacle 142 may then be discarded after the receptacle 142 has been removed from the aerosol provision device 100.

Referring to FIG. 2B, there is shown a schematic cross-section of an example of an aerosol provision device 200. Similar to FIG. 2A, there is shown a consumable 201, a device housing 262, a receptacle 242 and a heating element 222. The receptacle 242 may be inserted into device housing 262. As shown in FIG. 2B, the receptacle 242 defines a heating chamber in which the consumable 201 may be inserted. The heating element 222 extends from an end 262a of the device housing 262 and protrudes from the end 262a of the device housing 262 into the heating chamber that is defined by the receptacle 242. The consumable 201 may then be inserted into the heating chamber to engage with the heating element 222. The receptacle 242 comprises a base 272. The base 272 is provided with an aperture 250 (for example, as shown in FIG. 3B). The base 272 defines a peripheral edge of the aperture. The edge defines a first side 242a and a second side 242b. The aperture 250 is the same shape as the heating element 222. The aperture 250 allows for the heating element 222 to protrude into the heating chamber, but also allows for sliding contact of the first side 242a and the second side 242b against the heating element 222. The base 272 acts as a contact feature arranged to make sliding contact with the heating element 222. The contact feature, in embodiments, is another feature protruding above or below the base 272, for example a flange or a scraper (not shown). The receptacle further comprises a wall 252 projecting from the base 272 to define the heating chamber that encircles the heating element 122 protruding into the heating chamber. The receptacle, in embodiments, includes a lip (not shown) that protrudes from the device chamber that allows the user to easily remove and insert the receptacle.

In FIG. 2B, the heating element 222 is shown as a substantially pin-shaped heating element.

In use, the receptacle 242 is inserted into the device housing 262 such that the sides 242a and 242b contact the heating element 222 and allow the heating element 222 through the aperture. The consumable 201 is then inserted into the heating chamber defined by the receptacle 242 to engage with the heating element 222. Once the consumable 201 has been heated within the heating chamber, and used by the user, the consumable 201 is removed from the aerosol provision device 200. The removal of the consumable 201 may leave residue around the heating element 222. Therefore, after use, the user may remove the receptacle 242. The first and second sides, 242a and 242b, allow for residue to be removed by contacting, and scraping, the heating element 222, and moving the residue off the heating element 222 as the receptacle 242 is removed. This allows for residue to be contained in the receptacle 242 after it has been removed from the device housing 262. The residue remaining in the receptacle 242 may then be discarded after the receptacle 242 has been removed from the aerosol provision device 200.

In FIGS. 2A and 2B, it is shown that the receptacles 142, 242 may be removable from the device housings 162, 262. It is envisaged that alternatively, or in addition, the heating elements 122, 222 may be removed from the aerosol provision devices 100, 200.

Referring to FIG. 3A, there is shown a schematic diagram of the base of the receptacle 142. As described in relation to FIG. 2A, there is provided an aperture 150 that can contact and surround the heating element 122 (not shown in FIG. 3A). The aperture 150 is sized and shaped to slidingly contact the heating element 122 (again, not shown in FIG. 3A), and, as shown, is shaped and sized to contact and surround a substantially blade-shaped heating element.

Referring to FIG. 3B, there is shown a schematic diagram of the base of the receptacle 242. As described in relation to FIG. 2B, there is provided an aperture 250 that can contact and surround the heating element 222 (not shown in FIG. 3B). The aperture 250 is sized and shaped to slidingly contact the heating element 222 (again, not shown in FIG. 3B), and, as shown, is sized and shaped to contact and surround a substantially pin-shaped heating element.

The receptacle 242 in embodiments comprises a resilient member (not shown). The resilient member defines the edge of the aperture 150, 250. The base 172, 272 may comprise the resilient member. The resilient member may be on the base 172, 272. In embodiments, the resilient member defines the base 172, 272. The resilient member defines the aperture 150, 250. In an undeformed state, the dimensions of the aperture 150, 250, for example, length and/or width may be smaller than the corresponding dimensions of the heating elements 122, 222. This facilitates the edges being biased against the heating elements 122, 222. The resilient member, in embodiments, is a silicone material, or other flexible material, for example rubber or plastic, or the like. The resilient member facilitates contact with the heating elements 122 and 222 to facilitate in cleaning the heating elements 122 and 222.

It is also envisaged that, in embodiments, the heating elements 122, 222 are retractable into the device housings 162, 262, such that the heating elements 122, 222 pass through the aperture so that residue may be cleaned away from the heating elements 122 and 222. The device housings 162 and 262 may include a slide, push button or pull lever (all not shown) to retract the heating elements 122 and 222 into the respective device housings 162 and 262.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a device housing defining a device chamber;
a heating element protruding into the device chamber from an end of the device chamber;
a receptacle defining a heating chamber arranged to receive at least a portion of a consumable comprising aerosolizable material; and
wherein the receptacle is at least partially removably disposed within the device chamber and comprises a contact feature arranged to make sliding contact with the heating element during removal of the receptacle from the device chamber.

2. The aerosol provision device of claim 1, wherein the receptacle comprises a base and the heating element is arranged to protrude through the base into the heating chamber.

3. The aerosol provision device of claim 2, wherein the base forms the contact feature.

4. The aerosol provision device of claim 2, wherein the base comprises an aperture through which the heating element extends, wherein the contact feature is defined by at least part of a side of the aperture.

5. The aerosol provision device of claim 4, wherein the base comprises a resilient member.

6. The aerosol provision device of any of claim 2, wherein the base locates at the end of the device chamber.

7. The aerosol provision device of claim 1, wherein the receptacle further comprises a wall projecting from the base to define the heating chamber that encircles the heating element protruding into the heating chamber.

8. The aerosol provision device of claim 1, wherein the receptacle comprises a lip configured to protrude from the device chamber.

9. The aerosol provision device of claim 1, wherein the receptacle is removably secured in the device chamber.

10. The aerosol provision device of claim 1, wherein the heating element is retractable from the device chamber.

11. The aerosol provision device of claim 1, wherein the heating element comprises a susceptor which is heatable by penetration with a varying magnetic field.

12. The aerosol provision device of claim 11, further comprising an inductor coil extending around the susceptor, wherein the inductor coil is configured to generate the varying magnetic field.

13. The aerosol provision device of preceding claim 1, wherein the heating element is substantially blade-shaped.

14. The aerosol provision device of claim 13, wherein the sides of the aperture are sized and shaped to make sliding contact with the substantially blade-shaped heating element.

15. The aerosol provision device of claim 1, wherein the heating element is substantially pin-shaped.

16. (canceled)

17. The aerosol provision device of preceding claim 1, wherein the aerosol provision device is a non-combustible aerosol provision device

18. The aerosol provision device of preceding claim 1 wherein the aerosol provision device is configured to heat non-liquid aerosolisable material.

19. A system, comprising:
a consumable; and
an aerosol provision device comprising:
a device housing defining a device chamber;
a heating element protruding into the chamber from an end of the device chamber;
a receptacle defining a heating chamber arranged to receive at least a portion of a consumable comprising aerosolisable material; and
wherein the receptacle is at least partially removably disposed within the device chamber and comprises a contact feature arranged to make sliding contact with the heating element during removal of the receptacle from the device chamber.

20-27. (canceled)

28. An aerosol provision system comprising:
an aerosol provision device according to claim 1; and
an article comprising aerosol generating material, wherein the article is dimensioned to be at least partially received within the heater assembly.

29-30. (canceled)

31. A receptacle for an aerosol provision device, the receptacle comprising:
a heating chamber arranged to receive at least a portion of a consumable comprising aerosolizable material, wherein the receptacle is at least partially removably disposed within a housing of the aerosol provision device;
the receptacle being arranged to removably receive a heating element in the housing; and
a contact feature arranged to make sliding contact with a heating element of the aerosol provision device during at least one of insertion and removal of the receptacle from the housing.
